(19) United States
(12) Patent Application Publication
(10) Pub. No.: US 2010/0214475 A1
(43) Pub. Date: Aug. 26, 2010

(54) MOBILE TERMINAL, DISPLAY APPARATUS DISPLAY METHOD FOR MOBILE TERMINAL, AND DISPLAY METHOD FOR DISPLAY APPARATUS

(75) Inventor: Masayuki YAZAWA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/564,355

(22) Filed: Sep. 22, 2009

(30) Foreign Application Priority Data
Feb. 25, 2009 (JP) 2009-42816

(51) Int. Cl. H04N 7/00; H04N 5/91; H04M 1/00

(52) U.S. Cl. 348/468; 386/83; 455/556.1; 348/E07.001

(57) ABSTRACT

A mobile terminal includes a recording unit configured to record television broadcast program; a first extracting unit configured to extract caption information from each of the television broadcast programs; a storage unit configured to store the caption information extracted by the first extracting unit for each of the television broadcast programs recorded by the recording unit; and a display unit configured to, when displaying a list of the programs recorded by the recording unit, display the caption information of each recorded television programs stored by the storage unit. The mobile terminal, is capable of displaying a list of programs recorded that allows users to identify the contents of the programs in detail even on a small display screen by extracting distinctive textual information about each of the recorded programs from textural information such as caption information contained in the programs.

### CROSS-REFERENCE TO RELATED APPLICATIONS

This application is based upon and claims the benefit of priority from the prior Japanese Patent Application No. 2003-41989 filed on Feb. 20, 2003; the entire contents of which are incorporated herein by reference.

### BACKGROUND OF THE INVENTION

1. Field of the Invention

The present invention relates to a mobile terminal, a display apparatus, a display method for a mobile terminal, and a display method for a display apparatus capable of displaying a list of television programs recorded so as to allow users to identify the content of each program in detail.

2. Description of the Related Art

An increasing number of mobile terminals such as mobile phones contain television reception capabilities to allow uses to receive and watch television broadcasts such as digital terrestrial television (DTT) broadcasts. Such mobile terminals typically include not only the television reception capabilities but also recording and playback capabilities. Accordingly, efforts have been made to improve user interfaces for listing programs recorded on mobile terminals.

For example, Japanese Patent Publication of Unexamined Applications (Kokai), No. 2004-253050 describes an information playback apparatus that provides improved user access for searching for video scenes during recording and/or playback of information. The information playback apparatus detects distinctive characters in captions, or distinctive characters in captions and non-textual additional information in captions, or only non-characteristic additional information in captions from closed caption (CC) information in television signals, analyzes changes in these kinds of information and associates changed information and video, thereby facilitating video scene searching in recording and/or playback.

When television programs such as DTT programs recorded on a mobile terminal such as a mobile phone are listed on the mobile terminal, typically a list of the program titles contained in program information or a list of still images (thumbnail images) contained in video information of the recorded programs is displayed.

However, listing of the titles of programs recorded has a problem that it is difficult for the user to identify the content of an installment of a regularly broadcast program by the title of the program alone, for example, if a number of installments of the program were recorded. Another problem with thumbnail listing of programs recorded is that the thumbnail images of the installments of a regularly broadcast program can be similar to one another, making it difficult for the user to identify the content of each of the recorded installments, for example. There is another problem that because the screen that can be displayed on a mobile terminal is limited in size, each of thumbnail images displayed on the undersized display will be too small for the user to identify the content of the program by the thumbnail.

Television broadcasting such as DTT contains textual information such as caption information and program information in addition to video and audio information. Therefore, it is desirable that textual information such as caption information contained in television programs be used to list programs recorded on a mobile terminal on the small display of the mobile terminal to provide detailed information about the programs.

### SUMMARY OF THE INVENTION

The present invention has been made in view of the problems to provide a mobile terminal, a display apparatus, and a display method for the mobile terminal capable of displaying a list of programs recorded to allow users to identify of the content of each program in detail even on a small display screen.

To address the problems, a mobile terminal according to the present invention comprises a recording unit configured to record television broadcast program; a first extracting unit configured to extract caption information from each of the television broadcast programs; a storage unit configured to store the caption information extracted by the first extracting unit for each of the television broadcast programs recorded by the recording unit; and a display unit configured to, when displaying a list of the programs recorded by the recording unit, display the caption information of each recorded television programs stored by the storage unit.

And a display apparatus according to the present invention comprises a recording unit configured to record television broadcast program; an first extracting unit configured to extract caption information from each of the television broadcast programs; a storage unit configured to store the caption information extracted by the first extracting unit for each of the television broadcast programs recorded by the recording unit; and a display unit configured to, when displaying a list of the programs recorded by the recording unit, display the caption information of each recorded television programs stored by the storage unit.

And a display method for a mobile terminal according to the present invention comprises a recording step for recording television broadcast program; a first extracting step for extracting caption information from each of the television broadcast programs; a storage step for storing the caption information extracted at the first extracting step for each of the television broadcast programs recorded at the recording step; and a display step for, when displaying a list of the programs recorded at the recording step, displaying the caption information of each recorded television programs stored at the storage step.

And a display method for a display apparatus according to the present invention comprises a recording step for recording television broadcast program; a first extracting step for extracting caption information from each of the television broadcast programs; a storage step for storing the caption information extracted at the first extracting step for each of the television broadcast programs recorded at the recording step; and a display step for, when displaying a list of the programs recorded at the recording step, displaying the caption information of each recorded television programs stored at the storage step.

The mobile terminal, the display apparatus, the display method for the mobile terminal, and the display method for the display apparatus according to the present invention are capable of displaying a list of programs recorded that allows users to identify the contents of the programs in detail even on a small display screen by extracting distinctive textual information about each of the recorded programs from textural information such as caption information contained in the programs.

### BRIEF DESCRIPTION OF THE DRAWINGS

Embodiments of the present invention will be described in detail based on the following figures, wherein:

FIG. 1A is a perspective view of a mobile terminal (mobile phone) according to the present invention in its closed position; FIG. 1B is a perspective view of the mobile terminal (mobile phone) according to the present invention in its open position;

FIG. 2 is a block diagram showing functions of the mobile terminal (mobile phone) according to the present invention;

FIG. 3 is a flowchart of a procedure of a recording control process performed by a mobile phone according to a first embodiment;

FIG. 4 is a flowchart of a procedure of a program list display process performed by the mobile phone according to the first embodiment;

FIG. 5 is a diagram illustrating a program list screen on the mobile phone according to the first embodiment;

FIG. 6 is a flowchart of a procedure of a recording control process performed by a mobile phone according to a second embodiment; and

FIG. 7 is a flowchart of a procedure of a program list display process performed by the mobile phone according to the second embodiment.

### DETAILED DESCRIPTION OF THE PREFERRED EMBODIMENTS

### First Embodiment

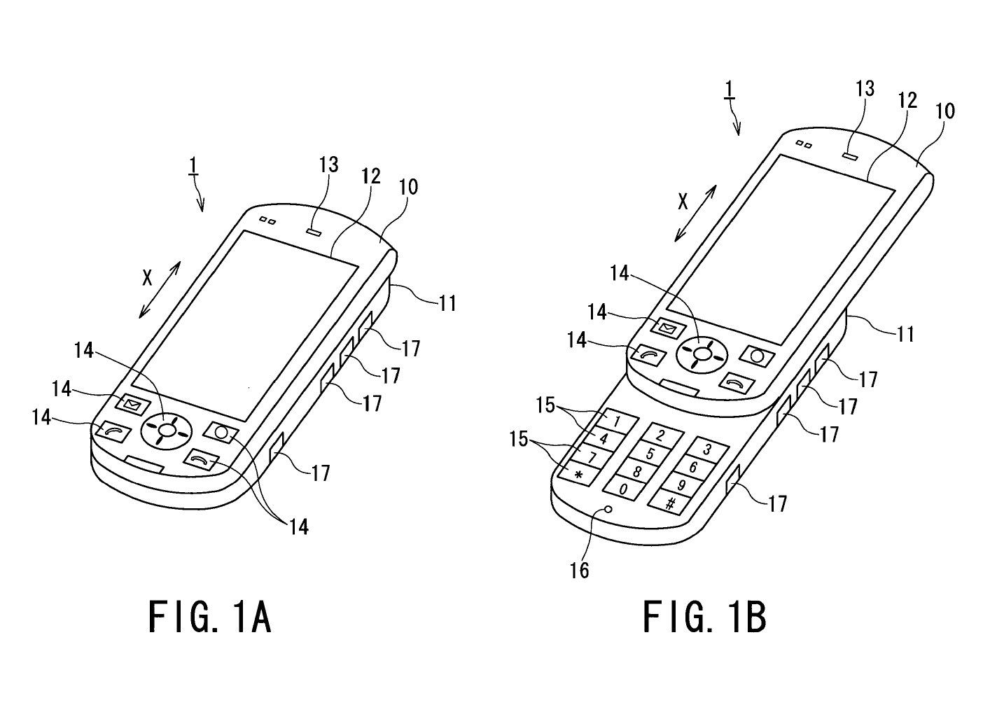

A first embodiment of a mobile terminal according to the present invention will be described with reference to FIGS. 1 to 5. For the purpose of illustration, the first embodiment will be described with respect to a slider mobile phone 1 that include two or more housings slidably coupled.

FIG. 1A is a perspective view of a mobile phone 1 in its closed position and FIG. 1B is a perspective view of the mobile phone 1 in its open position. The mobile phone 1 includes a rectangular plate-like upper housing 10 and a lower housing 11 similar in shape to the upper housing 10 as shown in FIGS. 1A and 1B. In the closed position, the upper and lower housings 10 and 11 are stacked on one another to entirely cover one another. The upper and lower housings 10 and 11 are coupled in such a manner that they can slide in a predetermined direction (for example along the direction of the length, namely in the X direction in FIGS. 1A and 1B a predetermined distance with respect to each other. By sliding the upper housing 10 along the lower housing 11, the mobile phone 1 is changed from the closed position to the open position or vice versa.

Provided on the outer surface of the upper housing 10 (the surface that does not face the lower housing 11) are a display 12 for displaying a screen including text and images and/or other information, a speaker 13 for outputting sound, and operation keys 14 to be pressed by a user to enter instructions. The operation keys 14 include a call initiation key for instructing the mobile phone 1 to initiate a call, a call end key for instructing to end a call, a mail key for activating a mail function, a television key for instructing to activate a television reception capabilities, a direction key for specifying up, down, left, and right directions.

The display 12, the speaker 13, and the operation keys 14 are exposed when the mobile phone 1 is in the closed position as well as in the open position. Accordingly, the user can view the screen and operate any of the operation keys 14 to input instructions when the mobile phone 1 is in the closed position as well as in the open position.

Provided on the inner surface of the lower housing 11 (the surface facing the upper housing 10) are operation keys 15 to be pressed by the user to enter instructions and a microphone 16 for collecting sound. The operation keys 15 are numeric and character keys for inputting numbers and characters, for example.

When the mobile phone 1 is in the closed position, the operation keys 15 and the microphone 16 are not exposed but covered with the upper housing 10. When the upper housing 10 is slid open with respect to the lower housing 11, the operation keys 15 and the microphone 16 are exposed. Accordingly, the user can input instructions through any of the operation keys 15 when the mobile phone 1 is in the open position, but cannot input instructions through the operation keys 15 when the mobile phone 1 is in the closed position. Therefore, the user changes the mobile phone 1 into the open position before inputting an instruction through any of the operation keys 15.

Side keys 17 to be pressed by the user to input instructions are provided on a side of the lower housing 11. These side keys 17 are exposed when the mobile phone 1 is in the closed position as well as in the open position. Therefore, the user can input an instruction through any of the side keys 17 when the mobile phone is in the closed position as well as in the open position.

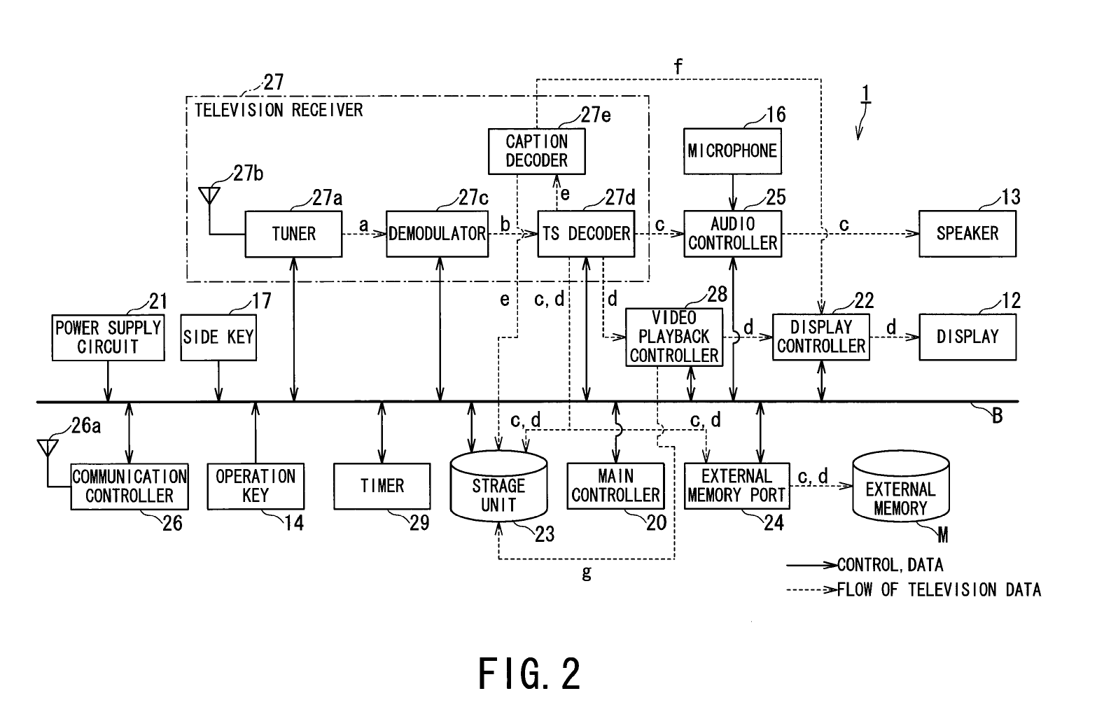

Functions of the mobile phone 1 will be described with reference to a block diagram of FIG. 2. As shown in FIG. 2, the mobile phone 1 includes a main controller 20, a power supply circuit 21, a display controller 22, a storage unit 23, an external memory port 24, an audio controller 25, a communication controller 26, a television receiver 27, a video playback controller 28, and a timer 29, which are communicably interconnected through a bus B.

The main controller 20 includes a CPU (Central Processing Unit) that performs various kinds of data processing and computational operations, centrally controls the mobile phone 1, and performs a recording control process, a program list display process and various other processes, which will be described later. The main controller 20 also includes an input interface for the operation keys 14, 15 and the side keys 17. When any of the operation keys 14, 15 and side keys 17 is pressed, the main controller 20 performs processing associated with the pressed key. The main controller 20 also includes an internal clock that constantly keeps track of the current time by using, for example, an RTC (Real Time Clock) circuit.

The power supply circuit 21 turns on and off power supply according to an input through any of the operation keys 14, 15 by the user. When the power supply is turned on, the power supply circuit 21 supplies power from a power source (such as a battery) to the components of the mobile phone 1 to activate the mobile phone 1. The display controller 22 includes a display interface for the display 12 and displays various display screens such as a television screen and a program list screen on the display 12 under the control of the main controller 20.

The storage unit 23 includes storage devices such as a RAM (Random Access Memory) temporarily storing data used by the main controller 20 for processing, a ROM (Read Only memory) storing processes programs of processing executed by the main controller 20, a hard disk, and a nonvolatile memory. Processes programs causing the main controller 20 to perform processes such as a recording control process and a program list display process, which will be described later, are stored in the ROM, for example.

The external memory port 24 includes input/output interfaces for external memory M such as an SD (Secure Digital) card (registered trademark) and USB (Universal Serial Bus) memory. When an external memory M is electrically connected to the mobile phone 1, the external memory port 24 performs processing for writing and reading data to and from the external memory M.

The audio controller 25, under the control of the main controller 20, generates an analog audio signal from sound collected through the microphone 16 and converts the analog audio signal to a digital audio signal. When the audio controller 25 acquires a digital audio signal, the audio controller 25, under the control of the main controller 20, converts the digital audio signal to an analog audio signal and outputs the analog audio signal as sound through the speaker 13.

The communication controller 26 applies spread-spectrum dispreading to a signal received through an antenna 26a to reconstruct data under the control of the main controller 20. The data is displayed on the display 12 or stored in the storage unit 23 according to an instruction from the main controller 20. The communication controller 26 applies, under the control of the main controller 20, spectrum spreading to data input through any of the operation keys 14, 15 and data stored in the storage unit 23 and sends out the resulting data through the antenna 26a.

The digital terrestrial television (DTT) receiver 27 includes a tuner 27a, a demodulator 27c, a TS decoder 27d, and a caption decoder 27e. The tuner 27a receives a modulated wave “a” of DTT (including digital terrestrial one-segment broadcasting) broadcast from a DTT broadcasting station (not shown) through an antenna 27b. The demodulator 27c acquires and demodulates a modulated wave “a” received at the tuner 27a to generate coded video information “b” of the DTT broadcast. The TS decoder 27d acquires and decodes the coded video information “b” generated by the demodulator 27c and sends audio information “c” in the coded video information “b” to the audio controller 25 or the storage unit 23 and also sends moving image information “d” in the coded video information “b” to the video playback controller 28 or the storage unit 23 and textual information “e” in the coded video information “b” to the caption decoder 27e or the storage unit 23.

When the audio controller 25 receives audio information “c”, the audio controller 25 outputs the audio information “c” as sound through the speaker 13. When the video playback controller 28 receives moving image information “d”, the video playback controller 28 displays the moving image information d on the display 12 through the display controller 22. When the caption decoder 27e receives textual information “e”, the caption decoder 27e generates caption information “f” from the textual information “e” and sends it to the display controller 22 or the storage unit 23.

When the video playback controller 28 acquires moving image information “d” of DTT received by the DTT receiver 27 or moving image information “d” stored in the storage unit 23, the video playback controller 28 displays the moving image information “d” on the display 12 through the display controller 22. The video playback controller 28 also stores an image file “g” of a still image at a predetermined time contained in the moving image information “d” in the storage unit 23 under the control of the main controller 20. The image file “g” is used for generating a thumbnail image for displaying a list of the moving image information “d” stored in the storage unit 23.

The timer 29 performs, according to an instruction from the main controller 20, timer processing for notifying the expiration of a predetermined time interval. When the timer 29 receives a timer start instruction from the main controller 20, the timer 29 starts measuring the predetermined time interval (timer time) in response to the timer start instruction from the main controller 20 and, upon expiration of the predetermined time interval, sends a timer expiration notification to the main controller 20.

Conventional mobile phones typically list the titles or thumbnail images of television programs recorded. Since multiple thumbnail images are displayed on the limited small display screen of mobile terminals, it is difficult for the user to identify the content of each recorded program to find a desired program on the program list. For example, when a weekly news show are recorded on the mobile phone 1 every week, its weekly installments may have thumbnail images which are similar to one another or may have the same program name, making it difficult for the user to distinguish the desired program to watch.

DTT broadcast waves received by the mobile phone 1 contain textual information such as caption information and program information in addition to image information and video information. The mobile phone 1 stores the textual information such as caption information contained in the programs recorded and, when listing the programs, displays the stored textual information in addition to thumbnail images of the programs. The textual information displayed may be extracted from a part of the textual information where modifier information is set, for example. Thus, the mobile phone 1 can straightforwardly extract and display distinctive textual information from programs without having to perform complex analysis of caption information.

In particular, when the mobile phone 1 receives and records a television program such as a DTT broadcast program, the mobile phone 1 extracts caption information from a stream of the television broadcast and stores a particular part of the caption information in the storage unit 23 as display information. The part stored is a part of the caption information that contains added control information (modifying information) indicating a display control mode such as a color or blinking. This is done because the part to which such modifying information is added are likely to be information intended to attract attention of users in the television program.

The header of a caption packet of television broadcast contains control codes for controlling the display function and display timing, for example. The control information here is control information that is added to parts to be highlighted in captions to be displayed and indicates control codes representing font size, font color, background color of font, blinking, underline, and the like.

If time information added to caption information indicates that there is a time interval between successive captions, it is likely that there may be a transition from one scene to the next in the program. Therefore, the caption information immediately after a time interval may be used as the display information. Alternatively, a part of caption information at the beginning of a television program or a part of caption information that appears after a predetermined time period after the beginning of the television program may be stored as display information.

When the mobile phone 1 displays a list of programs recorded, the mobile phone 1 retrieves the display information that was stored during the recording of each program and displays the display information on the screen 30 on the display 12. The list of the programs recorded may be displayed on the screen 30 so as to fit in the screen 30 or may be superimposed as a scrolling caption. The list may be displayed in a different color or blinked according to modifying information contained in the caption information. Alternatively, the mobile phone 1 may display thumbnail images of the programs with the list of programs recorded and, only when a cursor is placed on one of the thumbnail images, may superimpose the display information on the thumbnail image or display the display information as a scrolling caption, rather than always displaying a part of caption information. Alternatively, the display information may be displayed in a different color or may be blinked when the cursor is placed on a thumbnail image.

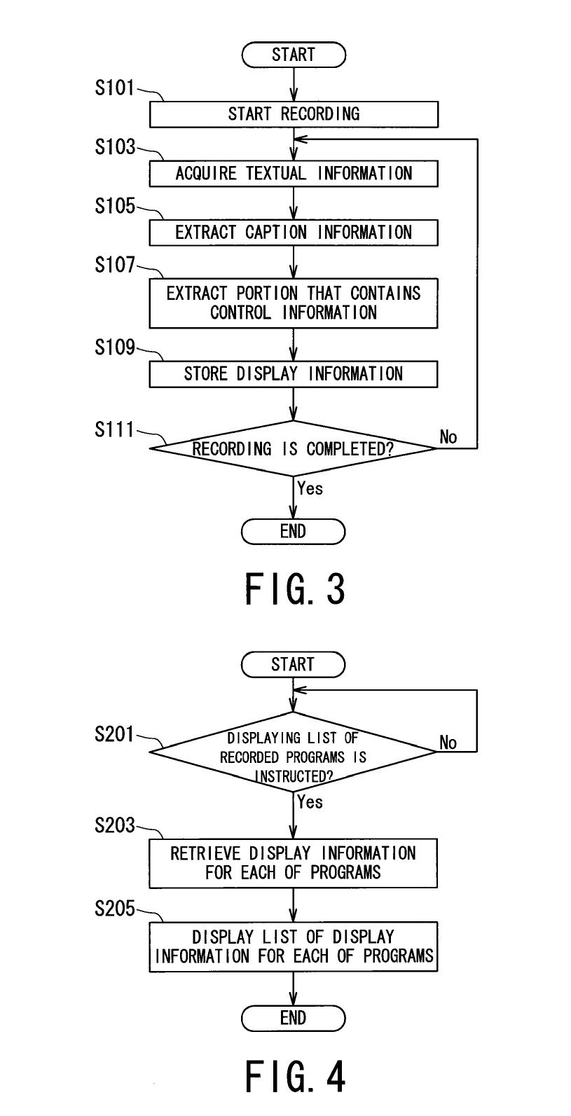

A procedure of a recording control process performed by the mobile phone 1 during recording a television program will be described with reference to the flowchart of FIG. 3. In the following description, “step” as in “step S101” will be sometimes abbreviated as “S” as in “S101”.

First, the main controller 20 starts a process for recording a television broadcast received according to a user operation (S101). During recording, the main controller 20 stores video information, audio information, and textural information in the television program from the television broadcast waves received by the television receiver 27 in the storage unit 23. The main controller 20 acquires textual information in the television program being recorded at step S101 (S103).

The main controller 20 extracts caption information from the textual information acquired at step S103 (S105). The caption information extracted may be caption information appearing within a predetermined time period (for example several seconds or minutes) from the start of the recording. Alternatively, the caption information may be the first series of caption information for playback of the television broadcast.

The main controller 20 extracts a portion of the caption information extracted at step S105 that contains control information as display information (S107). The control information is modifying information added to parts of caption information to be highlighted, for example a part to be displayed in a specified color, to be blinked, to be displayed in a specified location, or to be displayed in a specified font size, for example. If the caption information extracted at step S105 does not contain control information, preferably the sequence of extraction of textual information from the television program at step S103 and extraction of caption information containing control information at step S105 is repeated until caption information containing control information is extracted, in order that the portion of the caption information that contains control information can be extracted without fail at step S107.

The main controller 20 stores the display information extracted at S107 in the storage unit 23 (S109). The main controller 20 determines whether the recording has been completed or not (S111). The main controller 20 ends the recording process started at step S101 according to a user operation or the timer 29.

If the recording has not yet been completed (“No” at S111), the procedure returns to step S103 and the main controller 20 repeats steps S103 through S111. When the recording has been completed (“Yes” at S111), the main controller 20 ends the recording control process. For example, display information for program A saying, “The opening ceremony has started . . . ”, display information for program B saying, “The torch relay traveled under heavy security . . . ”, display information for program C saying, “when Japanese athletes entered . . . ”, and so on have been stored at step S109.

In this way, the mobile phone 1 extracts a part containing control information from caption information contained in a television program and sores the part as display information during recording of the television program. The display information is used when a list of programs recorded is displayed.

According to a subsequent user operation, the mobile phone 1 performs a program list display process for displaying a list of television programs which were recorded by performing steps S101 through S111. A procedure of the program list display process performed by the mobile phone 1 will be described with reference to the flowchart of FIG. 4.

When the user wants to watch a television program recorded on the mobile phone 1, the user instructs the mobile phone 1 to list the recorded programs by inputting an instruction through appropriated ones of the operation keys 14, 15 and side keys 17. The main controller 20 determines whether or not an instruction to display a list of programs recorded has been issued (S201). Here, the main controller 20 determines on the basis of a predetermined operation through appropriate operation keys 14, 15 and side keys 17 that the instruction to display a list of recorded programs has been issued or not. If the instruction to display a list of programs recorded has not been issued (“No” at S201), the main controller 20 remains in the wait state.

When the instruction to display a list of programs recorded has been issued (“Yes” at S201), the main controller 20 retrieves display information for the television programs stored in the storage unit 23 (S203). The main controller 20 displays a list of the display information retrieved at step S203 on the screen 30 on the display 12 (S205).

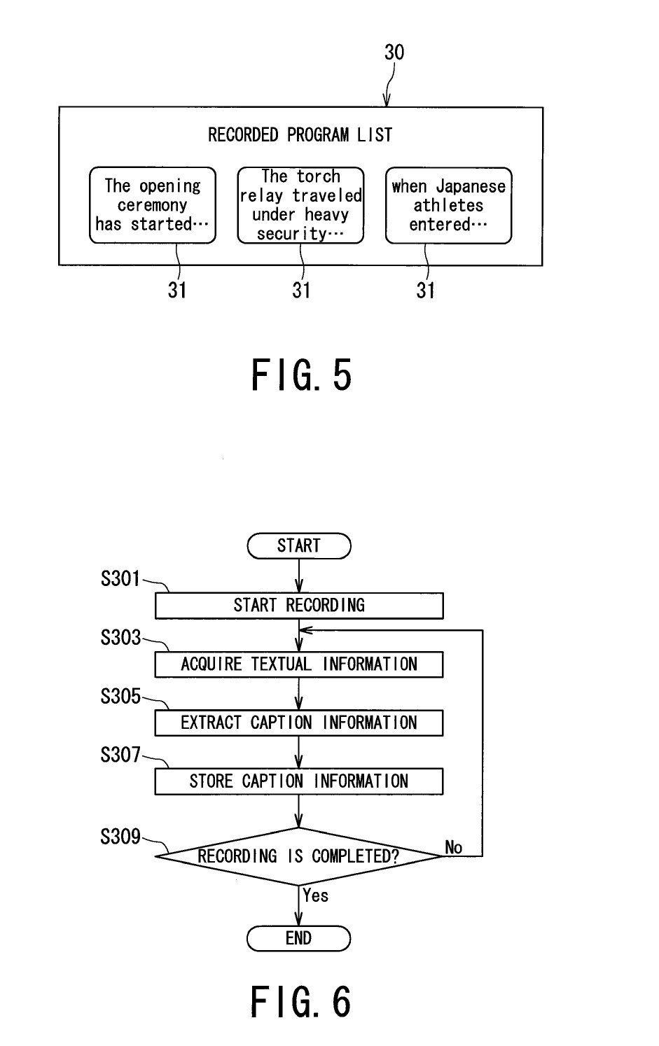

FIG. 5 illustrates the screen 30 on the display 12 displaying a list of programs recorded. As shown in FIG. 5, a list of options 31 on which display information stored at step S109 for each recorded program is displayed is displayed on the screen 30 (for example, options 31 on which display information “The opening ceremony has started . . . ” for program A, “The torch relay traveled under heavy security . . . ” for program B, and “when Japanese athletes entered . . . ” for program C is displayed). The user uses operation keys 14, 15, and side keys 17 to select the option 31 indicating the desired program recorded to select the desired program recorded.

In this way, when listing programs recorded, the mobile phone 1 displays a list of display information that was extracted from caption information during recording of television programs. When the user wants to watch any of the programs recorded, the user can identify the content of each of the programs on the basis of the display information and select the desired recorded program.

If a television program being recorded does not contain caption information, program information may be extracted at step S105 instead of caption information and may be stored at step S109. In this case, the program information is displayed at step S205 instead of caption information.

Video information may be acquired together with textual information at step S103, a still image (thumbnail image) at a given time may be extracted form the video information together with the caption information at step S105, and the thumbnail image may be stored together with the display information at step S109. In this case, preferably the thumbnail image is acquired together with the display information at step S203 and the display information and the thumbnail information are displayed at the same time at step S205. The thumbnail image displayed with the display information is preferably the one acquired at the time the textual information was acquired at step S103.

Alternatively, whenever the mobile phone 1 displays a list of programs recorded, the mobile phone 1 may first display the thumbnail image of the first scene of each program. Then, when the cursor is placed on the thumbnail image of a program, the mobile phone 1 may display the display information together with the thumbnail image of the scene displayed at the time the display information appears.

According to the first embodiment, distinctive textual information for each program recorded is extracted from textual information such as caption information contained in the program and is displayed on the display screen when a list of the programs recorded is displayed. Accordingly, the list of the programs recorded can be displayed in such a manner that the user can identify the content of each program in detail even on the small screen 30 on the display 12. The user can identify the content of each program recorded on the mobile terminal and can readily select a desired program to watch on the mobile terminal.

### Second Embodiment

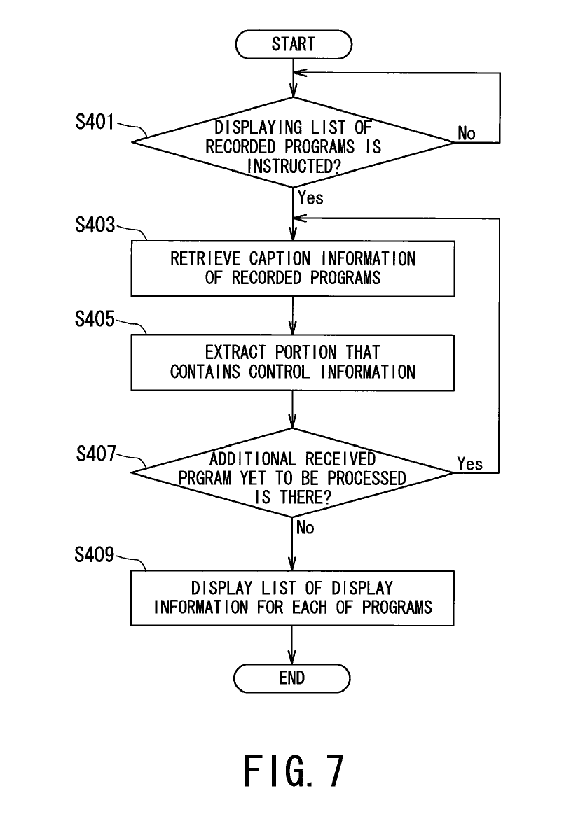

A second embodiment of a mobile terminal according to the present invention will be described with reference to FIGS. 6 and 7. The same components as those of the first embodiment are labeled the same reference numerals, repeated description of which will be omitted. The mobile terminal according to the second embodiment is a mobile phone having the same configuration as the mobile phone 1 of the first embodiment as illustrated in FIGS. 1A and 1B. Like the mobile phone 1 of the first embodiment, the mobile phone 1 of the second embodiment includes a main controller 20, a power supply circuit 21, a display controller 22, a storage unit 23, an external memory port 24, an audio controller 25 a communication controller 26, a television receiver 27, a video playback controller 28, and a timer 29, which are communicably interconnected through a bus B as shown in FIG. 2.

While the mobile phone 1 of the first embodiment extracts display information during recording television programs, the mobile phone 1 of the second embodiment extracts display information when listing programs recorded.

A procedure of the recording control process performed by the mobile phone 1 of the second embodiment will be described with reference to the flowcharts of FIGS. 6 and 7. First, the main controller 20 starts recording of a television broadcast being received according to a user operation (S301). During the recording, the main controller 20 stores in the storage unit 23 video information, audio information, and textual information in the television program being recorded from the television broadcast waves received by the television receiver 27.

The main controller 20 acquires textual information from the television program being recorded at step S301 (S303). The main controller 20 extracts caption information from the textual information acquired at step S303 (S305). The main controller 20 stores the textual information extracted at step S305 in the storage unit 23 (S307).

The main controller 20 determines whether the recording has been completed (S309). The main controller 20 ends the recording started at step S301 according to a user operation or the timer 29. If the recording has not been completed (“No” at S309), the procedure returns to step S303 and the main controller 20 repeats steps S303 through 5309. When the recording has been completed (“Yes” at S309), the main controller 20 will end the recording control process.

In this way, the mobile phone 1 extracts and stores the textual information contained in the television program during recording the television program. The textual information will be used when a list of programs recorded is displayed.

According to a user operation, the mobile phone 1 subsequently performs a program list display process for displaying a list of television programs that were recorded by performing steps S301 through S309. A procedure of the program list display process performed by the mobile phone 1 will be described with reference to the flowchart of FIG. 7.

When the user wants to watch a program recorded on the mobile phone 1, the user instructs the mobile phone 1 to display a list of the programs recorded by inputting the instruction through appropriate operation keys 14, 15 and side keys 17. The main controller 20 determines whether an instruction to display a list of programs recorded has been issued or not (S401). The main controller 20 determines on the basis of a predetermined operation performed through the appropriate operation keys 14, 15 and side keys 17 whether the instruction has been issued. If the instruction has not been issued (“No” at S401), the main controller 20 remains in the wait state.

When the instruction to display a list of the programs recorded has been issued (“Yes” at S401), the main controller 20 acquires caption information of one of the television programs stored in the storage unit 23 (S403). The main controller 20 then extracts a part containing control information from the caption information acquired at step S403 as display information (S405). The control information is modifying information added to each part to be highlighted in the caption information.

The main controller 20 determines whether there is an additional recorded program yet to be processed (S407). That is, the main controller 20 determines there is a program that is yet to undergo processing at steps S403 through S405 among the programs stored in the storage unit 23. If so (“yes” at step S407), the main controller 20 returns to step S403 and repeats steps S403 through S405.

If there is not an additional recorded program to process (“No” at S407), the main controller 20 displays a list of the display information extracted at step S405 on the screen 30 on the display 12, as in step S205 (S409).

In this way, the mobile phone 1 extracts a part containing control information from caption information that was stored during recording each television program as display information for the television program and displays a list of the display information when listing the recorded programs. When the user wants to watch any of the television programs recorded, the user can identify the content of each recorded program on the basis of the display information and select the desired recorded program.

According to the second embodiment, distinctive textual information is extracted from textual information such as caption information contained in broadcast programs recorded and a list of the recorded programs with the extracted textual information is displayed to allow the user to identify the content of each of the recorded programs in detail even on a small screen 30 on the display 12. Therefore, the user can identify the content of each recorded program in detail and readily select and watch a desired program on the mobile terminal.

While the present invention has been described with respect to mobile phones 1, the present invention is not limited to mobile phones. The present invention is applicable to any mobile terminals, such as PHS (Personal Handyphone System) terminals, PDAs (Personal Digital Assistants), handheld game machines, or portable television equipment that include television reception and recording capabilities.

What is claimed is:

1. A mobile terminal, comprising:
a recording unit configured to record television broadcast program;
a first extracting unit configured to extract caption information from each of the television broadcast programs;
a storage unit configured to store the caption information extracted by the first extracting unit for each of the television broadcast programs recorded by the recording unit; and
a display unit configured to, when displaying a list of the programs recorded by the recording unit, display the caption information of each recorded television programs stored by the storage unit.

2. The mobile terminal according to claim 1, wherein the first extracting unit keeps up extracting the caption information during predetermined period from time at which the recording unit starts recording.

3. The mobile terminal according to claim 1, wherein:
the first extracting unit extracts portion that contains control information;
the storage unit stores the portion extracted by the first extracting unit; and
the display unit displays the portion stored by the storage unit.

4. The mobile terminal according to claim 1, wherein the first extracting unit keeps up extracting the caption information from time at which the recording unit starts recording to time at which the first extracting unit extracts portion that contains control information for the first time.

5. The mobile terminal according to claim 1 comprising a second extracting unit configured to extract portion that contains control information from the caption information stored by the storage unit wherein the display unit displays the portion extracted by the second extracting unit.

6. The mobile terminal according to claim 3, wherein the first extracting unit extracts television broadcast program information if the program recorded by the recording unit does not include the caption information.

7. The mobile terminal according to claim 1 comprising a third extracting unit configured to extract still image of predetermined time from video picture of television broadcast program recorded by the recording unit, wherein:
the storage unit stores the still image extracted by the third extracting unit in conjunction with the caption information; and
the display unit concurrently displays the still image and the caption information stored by the storage unit.

8. A display apparatus, comprising:
a recording unit configured to record television broadcast program;
an first extracting unit configured to extract caption information from each of the television broadcast programs;
a storage unit configured to store the caption information extracted by the first extracting unit for each of the television broadcast programs recorded by the recording unit; and
a display unit configured to, when displaying a list of the programs recorded by the recording unit, display the caption information of each recorded television programs stored by the storage unit.

9. The display apparatus according to claim 8, wherein the first extracting unit keeps up extracting the caption information during predetermined period from time at which the recording unit starts recording.

10. The display apparatus according to claim 8, wherein:
the first extracting unit extracts portion that contains control information;
the storage unit stores the portion extracted by the first extracting unit; and
the display unit displays the portion stored by the storage unit.

11. A display method for a mobile terminal, comprising:
a recording step for recording television broadcast program;
a first extracting step for extracting caption information from each of the television broadcast programs;
a storage step for storing the caption information extracted at the first extracting step for each of the television broadcast programs recorded at the recording step; and
a display step for, when displaying a list of the programs recorded at the recording step, displaying the caption information of each recorded television programs stored at the storage step.

12. The display method for the mobile terminal according to claim 11, wherein the caption information is extracted during predetermined period from time at which the recording unit starts recording at the first extracting step.

13. The display method for the mobile terminal according to claim 11, wherein:
portion that contains control information is extracted at the first extracting step;
the portion extracted at the first extracting step is stored at the storage step; and
the portion stored at the storage step is displayed at the display step.

14. The display method for the mobile terminal according to claim 11, wherein the caption information is extracted from start time of recording to time at which portion that contains control information is extracted for the first time at the first extracting step.

15. The display method for the mobile terminal according to claim 11 comprising a second extracting step for extracting portion that contains control information from the caption information stored at the storage step wherein the portion extracted at the second extracting step is displayed at the display step.

16. The display method for the mobile terminal according to claim 13, wherein television broadcast program information is extracted at the first extracting step if the program recorded at the recording step does not include the caption information.

17. The display method for the mobile terminal according to claim 11 comprising a third extracting step for extracting still image of predetermined time from video picture of television broadcast program recorded at the recording step wherein:
the still image extracted at the third extracting step is stored in conjunction with the caption information; and
the still image and the caption information stored at the storage step are displayed concurrently at the display step.

18. A display method for the display apparatus, comprising:
a recording step for recording television broadcast program;
a first extracting step for extracting caption information from each of the television broadcast programs;
a storage step for storing the caption information extracted at the first extracting step for each of the television broadcast programs recorded at the recording step; and
a display step for, when displaying a list of the programs recorded at the recording step, displaying the caption information of each recorded television programs stored at the storage step.

19. The display method for the display apparatus according to claim 18, wherein the caption information is extracted during predetermined period from start time of recording at the first extracting step.

20. The display method for the display apparatus according to claim 18, wherein:
portion that contains control information is extracted at the first extracting step;
the portion extracted at the first extracting step is stored at the storage step; and
the portion stored at the storage step is displayed at the display step.
